(19) United States
(12) Patent Application Publication
(10) Pub. No.: US 2019/0222105 A1
(43) Pub. Date: Jul. 18, 2019

(54) ROTATING ELECTRIC MACHINE

(71) Applicant: Toyota Jidosha Kabushiki Kaisha, Toyota-shi Aichi-ken (JP)

(72) Inventor: Yasuhide Yagyu, Toyota-shi Aichi-ken (JP)

(21) Appl. No.: 16/243,387

(22) Filed: Jan. 9, 2019

(30) Foreign Application Priority Data
Jan. 15, 2018 (JP) 2018-004316

(51) Int. Cl. H02K 21/02; H02K 1/27; H02K 21/14

(52) U.S. Cl. CPC H02K 21/029; H02K 21/14; H02K 1/278; H02K 1/276

(57) ABSTRACT

A rotating electric machine is configured to include a rotor, a stator that includes a stator core and at least one coil that is wound on the stator core by distributed winding, and a plurality of non-magnetic conductors that respectively forma closed circuit and are arranged in the rotor such that magnetic flux from the stator interlinks an inside of the closed circuit, thereby reducing losses while preventing a decrease of the output torque.

### CROSS-REFERENCE TO RELATED APPLICATION

The present disclosure claims priority to Japanese Patent Application No. 2018-4316 filed on 15 Jan. 2018, which is incorporated herein by reference in its entirety including specification, drawings and claims.

### TECHNICAL FIELD

The present disclosure relates to a rotating electric machine configured to include a rotor, and a stator that includes a stator core and at least one coil that is wound on the stator by distributed winding.

### BACKGROUND

A conventionally known rotating electric machine is configured to include a rotor that includes a variable magnetic force magnet with a small product of coercive force and a thickness in a magnetization direction and a fixed magnetic force magnet with a large product of the coercive force and the thickness in the magnetization direction, a stator that is disposed outside of the rotor in a radial direction via an air gap, and thin plate-like conductive plates that are embedded in a rotor core so as to cover whole of upper and lower surfaces of the fixed magnetic force magnet (as shown in, for example, Patent Literature 1). In the rotating electric machine, the variable magnetic force magnet forms a magnetic pole of the rotor and is magnetized by a magnetic field from the stator caused by a d-axis current so as to irreversibly change the amount of magnetic flux of the variable magnetic force magnet. When the magnetic field caused by the magnetizing current of the variable magnetic force magnet passes through the conductive plate, an induced current (eddy current) flows in the conductive plate so as to generate a magnetic field that cancels a magnetic force of a magnetic field caused by the magnetizing current through the fixed magnetic force magnet. This prevents an increase of the d-axis current associated with the magnetization of the variable magnetic force magnet.

### CITATION LIST

### Patent Literature

PTL1: Japanese Patent Application Laid Open No. 2010-148179

### SUMMARY

In the conventional rotating electric machine in which the conductive plates are embedded in the rotor core so as to cover whole of upper and lower surfaces of the fixed magnetic force magnet, however, magnetic reluctance in a magnetic path of the magnet increases and output torque of the rotating electric machine decreases. On the other hand, in a rotating electric machine that includes at least one coil wound on a stator core by distributed winding, a higher harmonic component corresponding to a switching frequency and the like is superimposed on an electric current applied to the coil from an inverter. This changes magnetic flux (magnetic flux density) passing through the rotor and increases an iron loss and the like. Further, in the rotor including the magnet, an eddy current is generated in the magnet in accordance with a change in magnetic flux passing through the magnet, so that the magnet generates heat and a magnetic loss is increased.

A subject matter of the disclosure is to reduce losses while preventing a decrease of output torque in the rotating electric machine with the rotor, and the stator that includes the stator core and at least one coil wound on the stator core by distributed winding.

The disclosure is directed to a rotating electric machine configured to include a rotor, and a stator that includes a stator core and at least one coil that is wound on the stator core by distributed winding. The rotating electric machine further includes a plurality of non-magnetic conductors that respectively form a closed circuit and are arranged in the rotor such that magnetic flux from the stator interlinks an inside of the closed circuit.

In the rotating electric machine according to the disclosure, the plurality of non-magnetic conductors respectively form the closed circuit and are arranged in the rotor such that magnetic flux from the coil that is wound on the stator core by distributed winding interlinks the inside of the closed circuit. Thus, an induced current is generated in each of the non-magnetic conductors when a higher harmonic component corresponding to a switching frequency and the like is superimposed on an electric current applied to the coil of the stator so that magnetic flux from the stator to the rotor changes. Magnetic flux caused by the induced current that flows in each of the non-magnetic conductors prevents a change in magnetic flux through the rotor. Further, the magnetic flux caused by the induced current that flows in the non-magnetic conductor cancels only the change in the magnetic flux passing through the rotor and does not affect magnetic flux that is caused by a fundamental harmonic of the electric current applied to the coil and does not substantially change in the rotor. As a result, the rotating electric machine according to the disclosure prevents the change in the magnetic flux passing through the rotor and reduces losses while preventing the decrease of the output torque.

The rotor may be configured to include a plurality of magnetic poles and the non-magnetic conductor may be disposed for each of the plurality of magnetic poles. This configuration favorably reduces losses of the rotating electric machine.

The rotor may be configured to include a plurality of magnets that are arranged to form the plurality of magnetic poles. The plurality of non-magnetic conductors may be arranged in the rotor such that the magnetic flux passing through the magnet corresponding to each of the plurality of non-magnetic conductors interlinks the inside of the closed circuit. In the rotating electric machine, the induced current is generated in each of the non-magnetic conductors and the magnetic flux caused by the induced current that flows in each of the non-magnetic conductors prevents a change in magnetic flux through the magnet when the higher harmonic component corresponding to the switching frequency and the like is superimposed on the electric current applied to the coil of the stator so that magnetic flux from the stator to the rotor changes. Accordingly, this configuration prevents an eddy current from being generated in each magnet so as to reduce heat generation of each magnet caused by the eddy current, thereby drastically reducing a magnetic loss.

The rotor may be configured to include the plurality of magnets for each of the plurality of magnetic poles. The plurality of magnets may be respectively enclosed with the non-magnetic conductor. This configuration favorably prevents the change in the magnetic flux passing through each of the magnets.

The rotor may be configured to include the plurality of magnets for each of the plurality of magnetic poles. The non-magnetic conductor may be disposed in the rotor so as to extend along an outer circumference of the plurality of magnets chat forms one magnetic pole.

The rotor may be configured to include a plurality of magnets that are arranged to form the plurality of magnetic poles. The plurality of non-magnetic conductors may be arranged in the rotor so as to respectively extend along an cuter circumference of the corresponding magnet on a side of an axial center of the rotor.

The plurality of magnets may be respectively disposed within a magnet embedding hole that is formed in the rotor. The non-magnetic conductor may be partially inserted into the magnet embedding hole. This configuration prevents an increase in size of the rotor due to an installation of the non-magnetic conductors.

The plurality of magnets may be arranged on an outer circumferential surface of the rotor at intervals in a circumferential direction so as to form the plurality of magnetic poles and may be respectively enclosed with the non-magnetic conductor. That is, the rotating electric machine according to the disclosure may be configured to include a surface magnet type rotor.

The rotor may be configured to include a plurality of magnets that are arranged on an outer circumferential surface of the rotor at intervals in a circumferential direction so as to form the plurality of magnetic poles. The plurality of non-magnetic conductors may be arranged in the rotor so as to respectively enclose a boundary portion between the plurality of magnetic poles that are formed by the plurality of magnets.

### BRIEF DESCRIPTION OF DRAWINGS

FIG. 1 is a schematic configuration diagram illustrating a rotating electric machine according to the disclosure;

FIG. 2 is a plan view illustrating the rotating electric machine according to the disclosure;

FIG. 3 is an enlarged view illustrating a rotor of the rotating electric machine according to the disclosure;

FIG. 4 is an enlarged view illustrating the rotor of the rotating electric machine according to the disclosure;

FIG. 5 is a schematic view illustrating an arrangement of non-magnetic conductors in the rotor of the rotating electric machine according to the disclosure;

FIG. 6 is a graph illustrating magnetic flux in a magnet of the rotor of the rotating electric machine according to the disclosure;

FIG. 7 is an enlarged view illustrating another rotor of the rotating electric machine according to the disclosure;

FIG. 8 is a schematic view illustrating an arrangement of non-magnetic conductors in another rotor of the rotating electric machine according to the disclosure;

FIG. 9 is an enlarged view illustrating yet another rotor of the rotating electric machine according to the disclosure;

FIG. 10 is a schematic view illustrating an arrangement of non-magnetic conductors in yet another rotor of the rotating electric machine according to the disclosure;

FIG. 11 is a plan view illustrating another rotor of the rotating electric machine according to the disclosure;

FIG. 12 is a plan view illustrating yet another rotor of the rotating electric machine according to the disclosure; and

FIG. 13 is a plan view illustrating another rotor of the rotating electric machine according to the disclosure.

### DESCRIPTION OF EMBODIMENTS

The following describes some embodiments of the disclosure with reference to drawings.

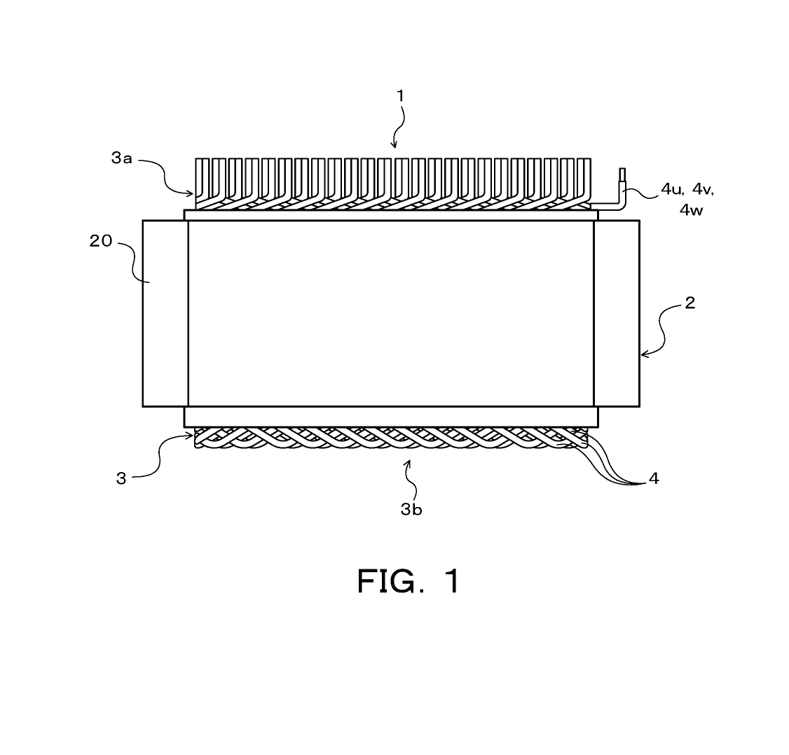

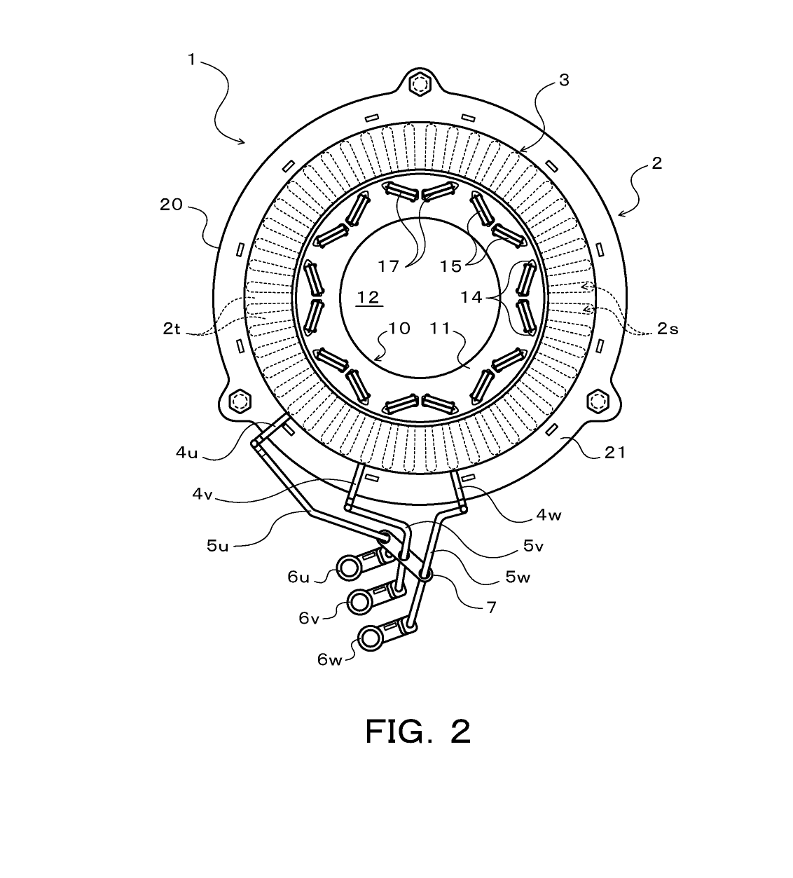

FIG. 1 is a schematic configuration diagram illustrating a rotating electric machine 1 according to the disclosure and FIG. 2 is a plan view illustrating the rotating electric machine 1. The rotating electric machine 1 shown in these figures is a three-phase AC motor used as a driving source and/or a generator of an electric vehicle, a hybrid vehicle and the like, for example. As shown in the figures, the rotating electric machine 1 is configured to include a stator 2 and a rotor 10 that is rotatably disposed within the stator 2 via an air gap.

The stator 2 includes a stator core 20 and a plurality of coils 3. The stator core 20 is formed by laminating a plurality of annular electromagnetic steel plates 21 (see FIG. 2) that are respectively formed by pressing, for example, so as to have an annular shape as a whole. The stator core 20 includes a plurality of teeth portions 2t respectively protruding inwardly in a radial direction at intervals in a circumferential direction from an annular outer circumferential portion (yoke) and a plurality of core slots 2s respectively formed between adjacent teeth portions 2t (see FIG. 2). An insulator (insulating paper) is disposed within each of the core slots 2s. The stator core 20 may be integrally formed by compression molding and sintering of ferromagnetic powder.

The plurality of coils 3 includes a U-phase coil, a V-phase coil and a W-phase coil. Each of the coils 3 is formed by electrically connecting a plurality of segment coils 4. The segment coil 4 is a substantially U-shaped conductor formed by bending a rectangular wire that includes an insulating layer (for example, enamel resin) formed on a surface of the wire and two tip portions from which the insulating layer is removed.

Two leg portions of each segment coil 4 are respectively inserted into the corresponding core slot 2s of the stator core 20. A portion of segment coil 4 protrudes from one end surface (an upper surface in FIG. 1) of the stator core 20 and bent by a bending apparatus (not shown). The tip portion of each bent segment coil 4 is electrically connected to the corresponding tip portion of another segment coil 4 by welding. As a result, the plurality of coils 3 are respectively wound on the stator core 20 by distributed winding. As shown in FIG. 1, each of the coils 3 includes two annular coil end portions 3a and 3b that respectively outwardly protrude from a corresponding end surface in an axial direction of the stator core 20.

Among multiple segment coils 4 inserted into the core slots 2s of the stator core 20, three segment coils (lead wire) 4u, 4v and 4w respectively include one end portion that is not connected to another segment coil 4. As shown in FIGS. 1 and 2, these end portions are bent toward an outer circumference of the stator core 20 and upward in FIG. 1 by the bending apparatus (not shown). The segment coil 4u is included in the U-phase coil, the segment coil 4v is included in the V-phase coil, and the segment coil 4w is included in the W-phase coil.

As shown in FIG. 2, the tip portion (portion where the insulating layer is removed, the same hereinafter.) of the segment coil 4u is electrically connected by welding to a tip potion of a power line 5u that is electrically connected to an U-phase terminal 6u. The tip portion of the segment coil 4v is electrically connected by welding to a tip potion of a power line 5v that is electrically connected to a V-phase terminal 6v. The tip portion of the segment coil 4w is electrically connected by welding to a tip potion of a power line 5w that is electrically connected to a W-phase terminal 6w. The power lines 5u, 5v and 5w are respectively fixed to a resin-made holding member 7. The terminals 6u, 6v and 6w are respectively fixed to a terminal block (not shown) arranged (fixed) on a housing of the rotating electric machine 1 when the stator 2 is assembled in the housing, and are connected to an inverter (not shown) via electric cables (not shown).

Further, resin such as varnish is applied to the stator core 20 from the coil end portions 3a of the coils 3 that protrude from an upper surface in FIG. 1 to the coil end portions 3b on a lower side in FIG. 1. Thus, each of segment coils 4 and the insulators (not shown) are fixed to the stator core 20 by the resin. Further, insulating powder is applied to exposed portions of the conductor such as connected potions between tip portions of the segment coils 4 and connected portions between the segment coils 4u-4w and the power lines 5u-5w and the like.

As shown in FIG. 2, the rotor 10 of the rotating electric machine 1 is so-called Interior Permanent Magnet (IPM type) rotor that includes a rotor core 11 that is fixed to a rotating shaft (not shown) and a plurality of (for example, 16 in the embodiment) permanent magnets 15 that are embedded in the rotor core 11 so as to form a plurality of (for example, 8 in the embodiment) magnetic poles. The rotor core 11 of the rotor 10 is formed by laminating a plurality of annular core plates respectively formed by pressing electromagnetic steel plate. The rotor core 11 includes a center hole 12 to which the rotating shaft is inserted and fixed, and a plurality of (for example, 16 in the embodiment) magnet embedding holes 14 that are long holes formed so as to respectively hold the permanent magnet 15.

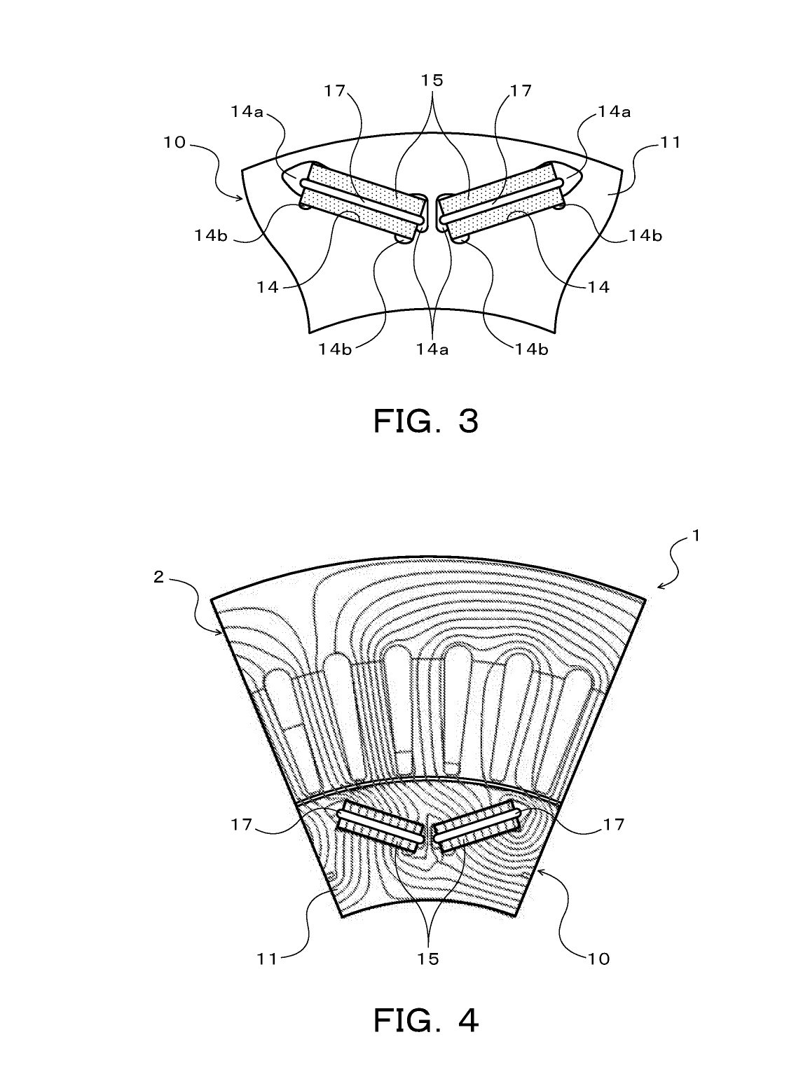

The plurality of magnet embedding holes 14 are arranged two by two at predetermined intervals (45° intervals in the embodiment) in the rotor core 11 so as to respectively passing through the rotor core 11 in an axial direction. As shown in FIG. 2, two magnet embedding holes 14 used in a pair are formed so as to be separated from each other (so as to form a V-shape) as extending from a side of an axial center of the rotor 10 to an outer circumference side. In the embodiment, a width of each magnet embedding hole 14 is longer than that of the permanent magnet 15. Thus, air gap portions 14a (see FIG. 3) are formed in both sides of each permanent magnet 15 in a width direction so as to prevent a short circuit of magnetic flux from the permanent magnet 15 when the permanent magnet 15 is disposed within the magnet embedding hole 14. Further, an inner circumferential surface of each magnet embedding hole 14 includes a recessed portion 14b with a curved surface for stress relaxation (see FIG. 3).

The permanent magnet 15 is a rare-earth sintered magnet such as a neodymium magnet and the like and is formed in a substantially rectangular parallelepiped shape. Two permanent magnets 15 used in a pair are respectively inserted and fixed in the corresponding magnet embedding hole 14 such that poles on a side of the outer circumference of the rotor 10 become identical to each other. The two permanent magnets 15 used in the pair are disposed in the rotor core 11 so as to be separated from each other as extending from the side of the axial center of the rotor 10 to the outer circumference side and form one magnetic pole of the rotor 10.

The rotor 10 of the above described rotating electric machine 1 is rotated by applying alternating current to each of the coils 3 from the PWM-controlled inverter (not shown). Further, in the rotating electric machine 1 including the coils 3 that is wound on the stator core 20 by distributed winding, a higher harmonic component corresponding to a switching frequency and the like is superimposed on the electric current applied to each of the coils 3 from the inverter, so that magnetic flux (magnetic flux density) from the stator 2 to the rotor 10 changes. This changes magnetic flux passing through the rotor 10 and each of the permanent magnets 15. Thus, when measures are not taken, an iron loss increases and an eddy current is generated in each of the permanent magnets 15 in accordance with a change in the magnetic flux. In addition, each of the permanent magnets 15 generates heat due to the eddy current, so that a magnetic loss is increased.

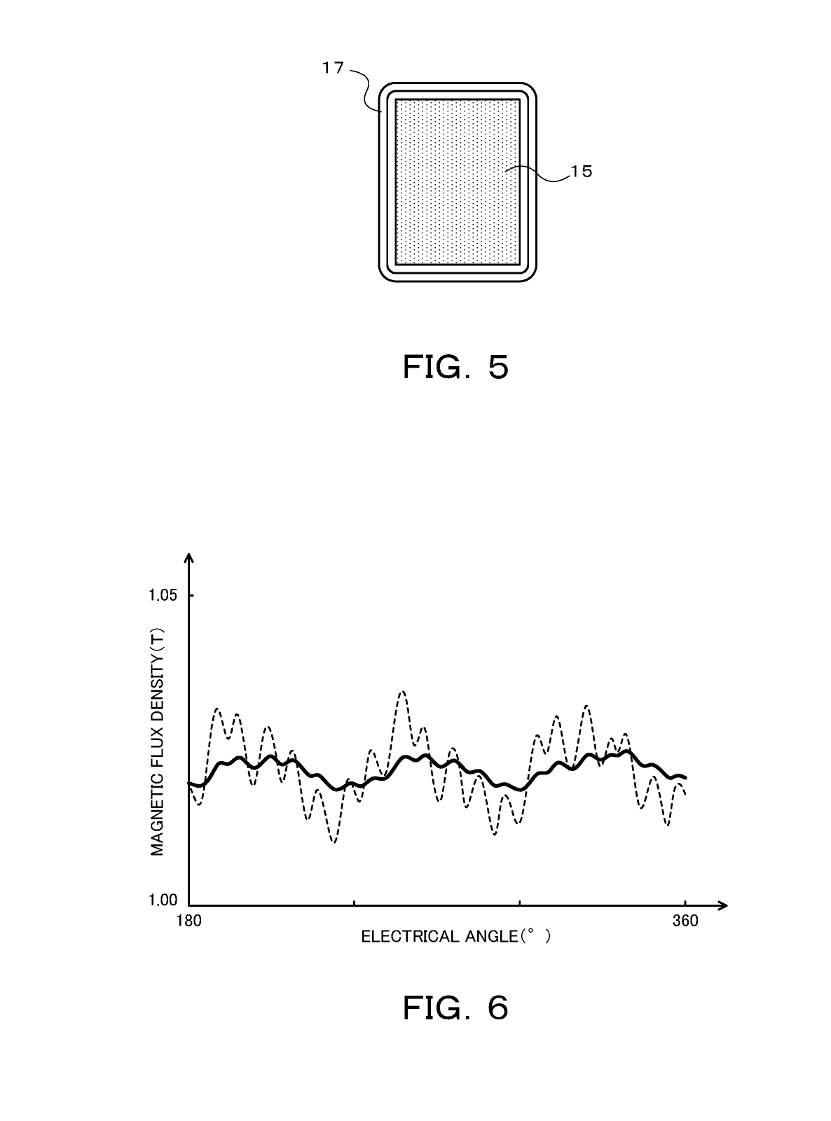

By taking into account the foregoing, as shown in FIGS. 3 and 4, a plurality of non-magnetic conductors 17 that respectively form a closed circuit are arranged in the rotor core 11 of the rotor 10. As shown in FIG. 5, each of the non-magnetic conductors 17 is a frame member mace of a non-magnetic conductive material such as a copper and the like and is formed so as to enclose the permanent magnet 15. The non-magnetic conductor 17 is disposed for each of the plurality of permanent magnets 15 forming the magnetic poles of the rotor 10. In the embodiment, as shown in FIG. 4, the non-magnetic conductor 17 is wound around each of the permanent magnets 15 such that magnetic flux from each of the coils 3 wounded on the stator core 20 by distributed winding interlinks an inside of the closed circuit (plane including the non-magnetic conductor 17) at an angle as close as possible to a right angle. Further, in the embodiment, portions of each non-magnetic conductor 17 extending in the axial direction of the rotor 10 are inserted into the air gap portions 14a of the magnet embedding hole 14 in which the corresponding permanent magnet 15 is disposed (see FIG. 3) and a resin is filled in the air gap portions 14a.

In the rotating electric machine 1 configured as described above, an induced current is generated in each of the non-magnetic conductors 17 when the higher harmonic component corresponding to the switching frequency and the like is superimposed on the electric current applied to each of the coils 3 of the stator 2 so that magnetic flux from the stator 2 to the rotor 10 changes. Magnetic flux caused by the induced current that flows in each of the non-magnetic conductors 17 prevents a change in the magnetic flux through each of the permanent magnets 15. That is, compared to the rotor 10 that does not include any non-magnetic conductor 17 (see a broken line in FIG. 6), the non-magnetic conductor 17 disposed for each of the plurality of permanent magnets 15 favorably prevents the change in the magnetic flux in and around each of the permanent, magnets 15 while maintaining an average flux density in and around each of the permanent magnets 15 substantially identical as shown by a solid line in FIG. 6.

As a result, the rotating electric machine 1 prevents the eddy current from being generated in each permanent magnet 15 so as to reduce heat generation of each permanent magnet 15 caused by the eddy current, thereby drastically reducing the magnetic loss to about one tenth of that in a rotating electric machine that does not include any non-magnetic conductor 17, for example. Further, the magnetic flux caused by the induced current that flows in each of the non-magnetic conductors 17 prevents a change in the whole of the magnetic flux passing through the rotor 10 so as to reduce the iron loss and the like, thereby reducing the loss of the whole of the rotating electrical machine 1 by about 10%, for example. The magnetic flux caused by the induced current that flows in each of the non-magnetic conductors 17 cancels only the change in the magnetic flux passing through the permanent magnet 15 (rotor 10) and does not affect magnetic flux that is caused by a fundamental harmonic of the electric current applied to the coils 3 and does not substantially change in the rotor 10. As a result, the rotating electric machine 1 prevents the change in the magnetic flux passing through the rotor 10 and favorably reduces losses such as the magnet loss, the iron loss and the like while preventing a decrease of output torque.

Further, the non-magnetic conductor 17 is disposed for each of the magnetic poles of the rotor 10 and for each of the permanent magnets 15, thereby favorably preventing the change in magnetic flux passing through each of the permanent magnets 15 and favorably reducing losses of the rotating electric machine 1. Moreover, each of the non-magnetic conductors 17 is partially inserted into the air gap portion 14a of the magnet embedding hole 14 into which the corresponding permanent magnet 15 is inserted. This configuration prevents an increase in a diameter (size) of the rotor 10 due to an installation of the non-magnetic conductors 17.

Upon the installation of the non-magnetic conductors 17 in the rotor core 11, both the permanent magnet 15 and the non-magnetic conductor 17 may be disposed within the magnet embedding hole 14 after the non-magnetic conductor 17 is wound around the permanent magnet 15. The non-magnetic conductor 17 may be wound around the permanent magnet 15 after the permanent magnet 15 is disposed within the magnet embedding hole 14. When the non-magnetic conductor 17 is disposed in the rotor core 11 after the permanent magnet 15 is disposed within the magnet embedding hole 14, two leg portions of an U-shaped non-magnetic conductor (segment) may be inserted into the corresponding air gap portions 14a from one end surface side of the rotor core 11 and end portions of the two leg portions of the non-magnetic conductor that protrude from the other end surface of the rotor core 11 may be bent and connected (welded) each other. In some embodiments, a resistance value of the non-magnetic conductor 17 is minimized as possible in consideration of heat generation due to the generation of the eddy current. As shown in FIG. 5, a space may be formed between the non-magnetic conductor 17 and an outer circumferential surface of the permanent magnet 15.

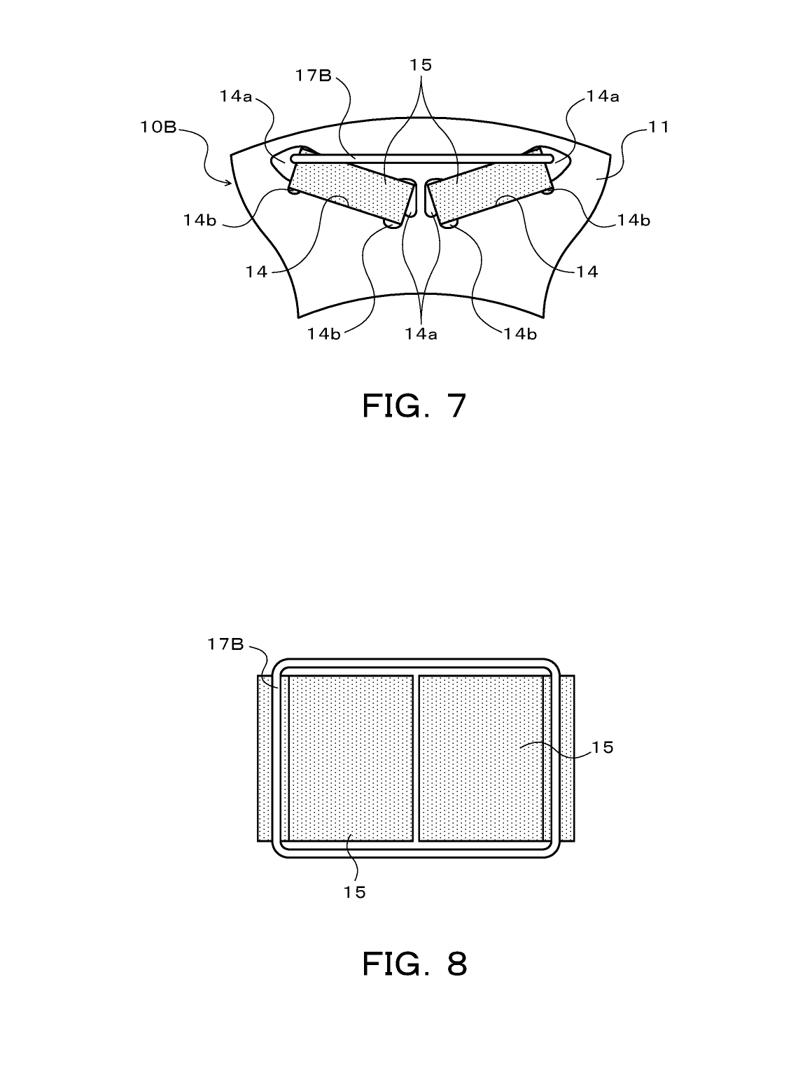

In the above rotor 10, the plurality of the non-magnetic conductors 17 are arranged in the rotor core 11 so as to enclose the corresponding one permanent magnet 15, but not limited to this. A rotor 10B shown in FIG. 7 may be applied to the rotating electric machine 1 of the disclosure. In the rotor 10B, as shown in FIGS. 7 and 8, the non-magnetic conductor 17B are disposed in the rotor core 11 so as to respectively extend along an outer circumference of two (the plurality of) permanent magnets 15 that forms one magnetic pole. The rotating electric machine 1 with the rotor 10B prevents the change in the magnetic flux passing through the rotor 10B and favorably reduces losses such as the magnet loss, the iron loss and the like while preventing the decrease of output torque. As shown in FIG. 7, the non-magnetic conductor 17B may be disposed on an outer circumference side of the rotor 10B with respect to two (the plurality of) permanent magnets 15 that forms one magnetic pole. The non-magnetic conductor 17B may be disposed on an axial center side of the rotor 10B with respect to two (the plurality of) permanent magnets 15 that forms one magnetic pole. The non-magnetic conductors 17B may be disposed on outer circumferential surface of the rotor core 11. The non-magnetic conductors 17B may be embedded in the rotor core 11 not to protrude from the outer circumferential surface of the rotor core 11.

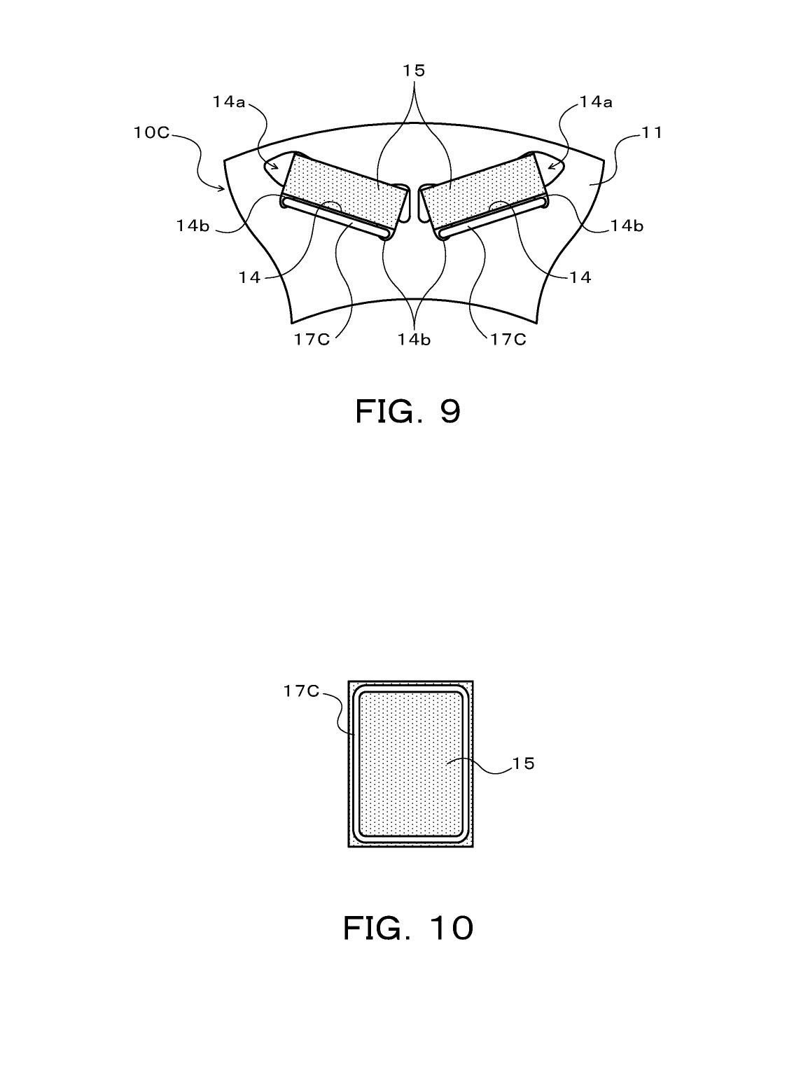

A rotor 10C shown in FIG. 9 may be applied to the rotating electric machine 1 of the disclosure. In the rotor 10C, as shown in FIGS. 9 and 10, non-magnetic conductors 17C are arranged in the rotor core 11 so as to respectively extend along an outer circumference of the corresponding permanent magnet 15 on a side of an axial center of the rotor 10C. The rotating electric machine 1 with the rotor 10C prevents the change in the magnetic flux passing through the rotor 10C and favorably reduces losses such as the magnet loss, the iron loss and the like while preventing the decrease of output torque. In the rotor 10C, two recessed portions 14b of the magnet embedding hole 14 that are disposed on the side of the axial center of the rotor 10C are enlarged. Portions of the non-magnetic conductor 17C extending in the axial direction of the rotor 10C are inserted into the two recessed portions 14b. This configuration prevents an increase in a diameter (size) of the rotor IOC due to an installation of the non-magnetic conductors 17C.

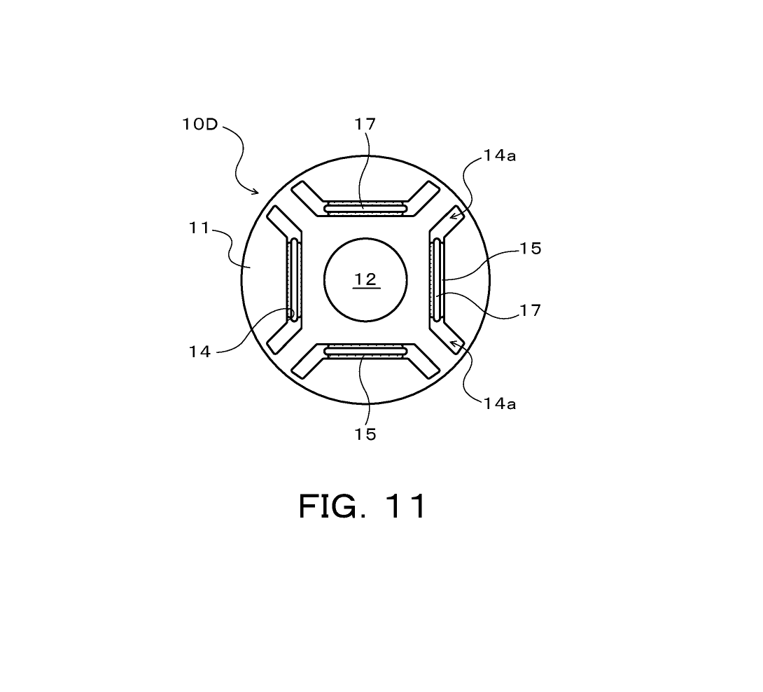

Further, the rotating electric machine 1 may be configured to include a rotor 10D with smaller number of magnetic poles than 8 poles, as shown in FIG. 11. The rotating electric machine 1 may be configured to include a rotor with larger number of magnetic poles than 8 poles.

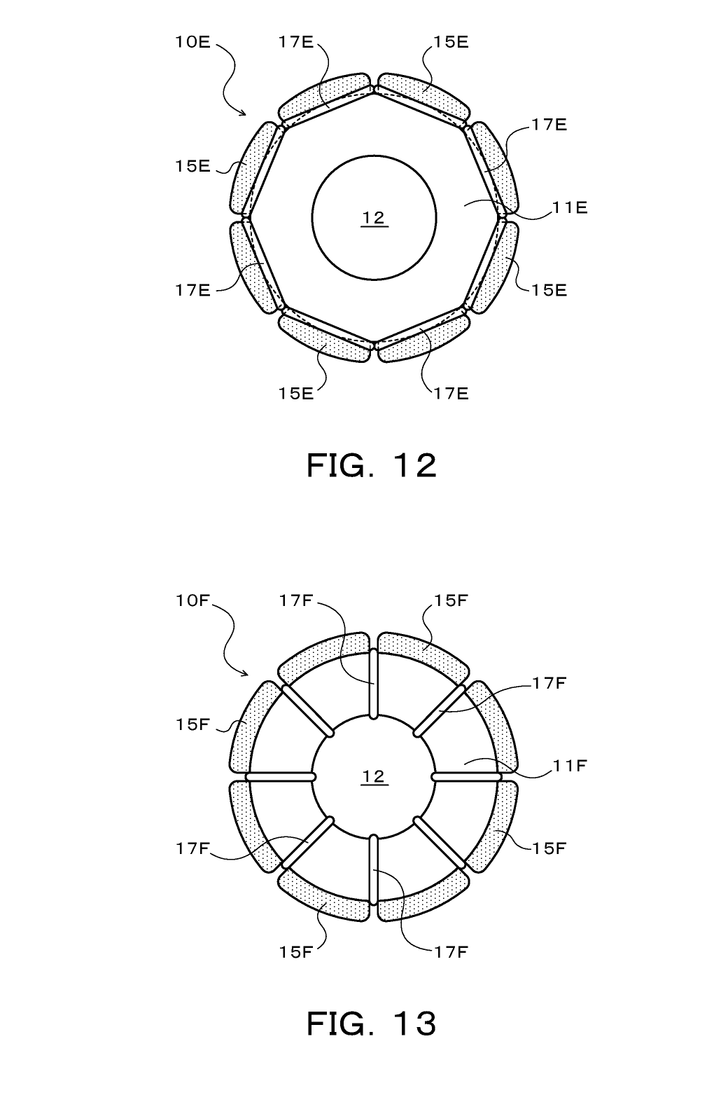

FIG. 12 is a plan view illustrating another rotor 10E applicable to the rotating electric machine 1 according to the disclosure. The rotor 10E shown in FIG. 12 is a so-called surface permanent magnet type (SPM type) rotor configured to include a plurality of permanent, magnets 15E that are arranged (fixed) on an outer circumferential surface of an annular rotor core 11E at intervals in a circumferential direction so as to form a plurality of magnetic poles. In the rotor 10E, a plurality of non-magnetic conductors 17E respectively form a closed circuit and are arranged in the rotor core 11E. Each of the non-magnetic conductors 17E is a frame member made of a non-magnetic conductive material such as a copper and the like and is formed so as to enclose the permanent magnet 15E. The non-magnetic conductor 17E is disposed for each of the plurality of permanent magnets 15E that form the magnetic poles of the rotor 10E. The non-magnetic conductor 17E is wound around each of the permanent magnets 15E such that magnetic flux from a stator core interlinks an inside of the closed circuit (plane including the non-magnetic conductor 17E) at an angle as close as possible to a right angle. The rotating electric machine 1 with the rotor 10E prevents the change in the magnetic flux passing through the rotor 10E and favorably reduces losses such as the magnet loss, the iron loss and the like while preventing the decrease of output torque.

Further, a surface magnet type rotor 10F shown in FIG. 13 may be applied to the rotating electric machine 1 of the disclosure. The rotor 10F shown in FIG. 13 is a so-called surface permanent magnet type (SPM type) rotor configured to include a plurality of permanent magnets 15F that are arranged (fixed) on an outer circumferential surface of a rotor core 11F at intervals in a circumferential direction so as to form a plurality of magnetic poles. Each of non-magnetic conductors 17F of the rotor 10F is a frame member made of a non-magnetic conductive material such as a copper and the like and is formed so as to enclose an outer circumference surface, an inner circumference surface and both end surfaces of the rotor core 11F. The non-magnetic conductors 17F are arranged in the rotor core 11F so as to respectively enclose a corresponding boundary portion between the plurality of magnetic poles that are formed by the plurality of permanent magnets 15F. The rotating electric machine 1 with the rotor 10F prevents the change in the magnetic flux passing through the rotor 10F and favorably reduces losses such as the magnet loss, the iron loss and the like while preventing the decrease of output torque.

As has been described above, in the rotating electric machine 1 according to the disclosure, the plurality of non-magnetic conductors 17, 17B, 17C, 17E, 17F or 17G respectively form the closed circuit and are arranged in the rotor 10, 10B, 10C, 10D, 10E, 10F or 10G such that magnetic flux from the coils 3 respectively wound on the stator core 20 by distributed winding interlinks the inside of the closed circuit. Thus, the induced current is generated in each of the non-magnetic conductors 17, 17B, 17C, 17E, 17F or 17G when the higher harmonic component corresponding to the switching frequency and the like is superimposed on the electric current applied to the coils 3 of the stator 90 so that magnetic flux from the stator 20 to the rotor 10, 10B, 10C, 10D, 10E, 10F or 10G changes. The magnetic flux caused by the induced current that flows in each of the non-magnetic conductors 17, 17B, 17C, 17E, 17F or 17G prevents the change in the magnetic flux through the rotor 10, 10B, 10C, 10D, 10E, 10F or 10G. Further, the magnetic flux caused by the induced current that flows in the non-magnetic conductor 17, 17B, 17C, 17E, 17F or 17G cancels only the change in the magnetic flux passing through the permanent magnet 15, the rotor 10 and the like and does not affect magnetic flux that is caused by the fundamental harmonic of the electric current applied to the coils 3 and does not substantially change in the rotor 10, 10B, 10C, 10D, 10E, 10F or 10G. As a result, the rotating electric machine 1 according to the disclosure prevents the change in the magnetic flux passing through the rotor 10, 10B, 10C, 10D, 10E, 10F or 10G and reduces losses while preventing the decrease of the output torque.

The coil 3 disposed in the stator 2 of the rotating electric machine 1 according to the disclosure may be any one that is wound on the stator core 20 by distributed winding and is not limited to the coil including the plurality of the segment coils 4.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The techniques according to the disclosure is applicable to, for example, the field of manufacture of the rotating electric machine.

1. A rotating electric machine configured to include a rotor, and a stator that includes a stator core and at least one coil that is wound on the stator core by distributed winding, the rotating electric machine comprising:
a plurality of non-magnetic conductors that respectively form a closed circuit and are arranged in the rotor such that magnetic flux from the stator interlinks an inside of the closed circuit.

2. The rotating electric machine according to claim 1,
wherein the rotor is configured to include a plurality of magnetic poles, and wherein the non-magnetic conductor is disposed for each of the plurality of magnetic poles.

3. The rotating electric machine according to claim 2,
wherein the rotor is configured to include a plurality of magnets that are arranged to form the plurality of magnetic poles, and wherein the plurality of non-magnetic conductors are arranged in the rotor such that the magnetic flux passing through the magnet corresponding to each of the plurality of non-magnetic conductors interlinks the inside of the closed circuit.

4. The rotating electric machine according to claim 3,
wherein the rotor is configured to include the plurality of magnets for each of the plurality of magnetic poles, and wherein the plurality of magnets are respectively enclosed with the non-magnetic conductor.

5. The rotating electric machine according to claim 3,
wherein the rotor is configured to include the plurality of magnets for each of the plurality of magnetic poles, and wherein the non-magnetic conductor is disposed in the rotor so as to extend along an outer circumference of the plurality of magnets that forms one magnetic pole.

6. The rotating electric machine according to claim 2, wherein the rotor is configured to include a plurality of magnets that are arranged to form the plurality of magnetic poles, and wherein the plurality of non-magnetic conductors are arranged in the rotor so as to respectively extend along an outer circumference of the corresponding magnet on a side of an axial center of the rotor.

7. The rotating electric machine according to claim 3,
wherein the plurality of magnets are respectively disposed within a magnet embedding hole that is formed in the rotor, and wherein the non-magnetic conductor is partially inserted into the magnet embedding hole.

8. The rotating electric machine according to claim 3,
wherein the plurality of magnets are arranged on an outer circumferential surface of the rotor at intervals in a circumferential direction so as to form the plurality of magnetic poles and are respectively enclosed with the non-magnetic conductor.

9. The rotating electric machine according to claim 1
wherein the rotor is configured to includes a plurality of magnets that are arranged on an outer circumferential surface of the rotor at intervals in a circumferential direction so as to form the plurality of magnetic poles, and wherein the plurality of non-magnetic conductors are arranged in the rotor so as to respectively enclose a boundary portion between the plurality of magnetic poles that are former by the plurality of magnets.
